(19) United States
(12) Patent Application Publication
(10) Pub. No.: US 2005/0001484 A1
(43) Pub. Date: Jan. 6, 2005

(54) EMC-optimized device for controlling a fan

(76) Inventors: Thomas Mohr, Buehlertal (DE); Nikolas Haberl, Lauf (DE)

Correspondence Address: KENYON & KENYON, ONE BROADWAY, NEW YORK, NY, 10004, US

(21) Appl. No.: 10/821,724

(22) Filed: Apr. 9, 2004

(30) Foreign Application Priority Data
Apr. 11, 2003 (DE) 103 16 641.6

(51) Int. Cl. H02J 1/10

(52) U.S. Cl. 307/24

(57) ABSTRACT

A method for controlling at least two electrical loads in a circuit arrangement. The at least two electrical loads are controlled with the aid of at least two pulse-width-modulated signals. An inductor and a capacitor influence the electromagnetic compatibility. An inductor current flowing in a lead is buffered by the inductor and the capacitor, the pulse-width-modulated signals being generated in a time-staggered manner, so that one of the electrical loads is switched on by one of the pulse-width-modulated signals, after the other electrical load is switched off beforehand by the other of the pulse-width-modulated signals.

### RELATED APPLICATION INFORMATION

This application claims the benefit of and priority to German Patent Application No. 103 16 641.6, which was filed in Germany on Apr. 11, 2003, and which is incorporated by reference.

### FIELD OF THE INVENTION

The present invention relates to an EMC-optimized device for controlling a fan.

### BACKGROUND INFORMATION

The different electrical and electronic systems installed in a motor vehicle, such as an ignition system, electronic injection system, ABS/ASR, airbag, car radio, car phone, and navigation systems, are positioned side-by-side in close spatial proximity. They must function next to each other and may not unduly affect each other. On one hand, the motor vehicle must neutrally fit in with its surroundings as a system, i.e. it may neither electrically influence other vehicles nor interfere with the transmission of radio, television, and other wireless services. On the other hand, the motor vehicle must remain fully functional in the presence of powerful electric fields (for example, in the vicinity of transmitters). For these reasons, electrical systems for motor vehicles, and motor vehicles as a whole, must be equipped to be electromagnetically compatible.

High-frequency, clock-pulse controllers are used for low-loss, continuously variable control of DC motors, such as those used as fan motors on cooling fans. EMC interference-suppression measures are used in order to minimize particularly long, line-conducted radiation, which affects the electromagnetic compatibility. These interference-suppression measures include chokes (inductors) and capacitors. If EMC measures are omitted, the electrical system of a motor vehicle is loaded with a high current. The inductance coils and capacitors used within the scope of EMC measures result in a current that has been high-pass filtered twice. In the long-wave and short-wave ranges, inductances and capacitances are essentially a function of the magnitude of the current (Iₘₐₓ), as well as the frequency f=1/Tₚ at which the clocking of a high-frequency, clock-pulse controller occurs. For acoustic reasons, clocking is generally done at frequencies≧20 kHz.

International Patent Application No. WO 88/10367 refers to a method for controlling electrical loads. When relatively large loads are switched, this method provides for them to be switched on and off in a time-staggered manner, so that a flowing current increases essentially continuously during the switching-on operation and decreases essentially continuously during the switching-off operation.

International Patent Application No. WO 98/58445 refers to a method for controlling at least two electrical loads. A common circuit configuration having pulse-width modulated signals is provided for this reason; a lead current, which flows during a pulse pause of the pulse-width-modulated signals and is a function of an inductance of the electrical connecting lines, being received (absorbed) by a buffer capacitor. The pulse-width-modulated signals are generated in a time-staggered manner. Preferably, the pulse-width-modulated signals are staggered in their generation in such a manner that, when the pulse-width-modulated signals are superposed, a simultaneous pulse pause of all the pulse-width-modulated signals is prevented. In a circuit arrangement having two electrical loads, these can be controlled by pulse-width-modulated signals, which have a pulse duty factor of 50% and are time-staggered by a half period.

### SUMMARY OF THE INVENTION

With the exemplary embodiment and/or exemplary method of the present invention, the EMC-measure components necessary for improving the electromagnetic compatibility, i.e. the inductors and capacitors, may be sized to have only half of their original inductances and capacitances, respectively. This allows the inductors and capacitors used in the EMC measure to be sized smaller, in particular with regard to the long-wave range.

For example, in the case of controlling a double fan on vehicle radiators, the two fan motors are controlled by a micro-controller. Each of the two fan motors is assigned a power semiconductor component, which is acted upon, in each instance, by a voltage U_{Gate1} or U_{Gate2} via an output of the micro-controller. When the two power semiconductors are controlled, using a pulse duty factor of 50%, the electrical system of a motor vehicle sees a direct current. According to the proposed method, the second electrical drive is powered precisely after the first electrical drive is switched off. In this context, the turn-on time of the second electrical drive always coincides with the turn-off time of the first electrical drive. When the power semiconductor components controlling the two motors are controlled, using a pulse duty factor of 50%, the electrical system of a motor vehicle sees a direct current. Optionally, the two electrical drives may be controlled, using different pulse duty factors. This allows the exemplary method of the present invention to be used for double fans. In this manner, the coolant of an internal combustion engine may be cooled, using an electrical drive designed as a fan drive, while the second electrical drive may be used, for example, as a fan for cooling the heat changer of the air conditioner, or for cooling a steering-assistance system (power-steering system) on a motor vehicle.

### BRIEF DESCRIPTION OF THE DRAWINGS

FIG. 1 shows an available circuit arrangement, in which the power semiconductor components are acted upon by a common control signal of a micro-controller.

FIG. 2 shows the voltage characteristic at the output of the micro-controller and the current flowing in the lead.

FIG. 3 shows voltages U_{Gate1}, U_{Gate2} applied to the outputs of the micro-controller of a circuit arrangement according to the present invention, as well as the current flowing in the lead, at a pulse duty factor of 40%.

FIG. 4 shows voltage curves U_{Gate1}, U_{Gate2} at the outputs of the micro-controller, as well as the maximum line current flowing in the lead, at a pulse duty factor of 50%.

FIG. 5 shows a circuit arrangement for controlling a double fan according to an exemplary embodiment of the present invention.

FIG. 6 shows the curves of control signals U_{Gate1}, U_{Gate2} generated at a pulse duty factor of 60%.

### DETAILED DESCRIPTION

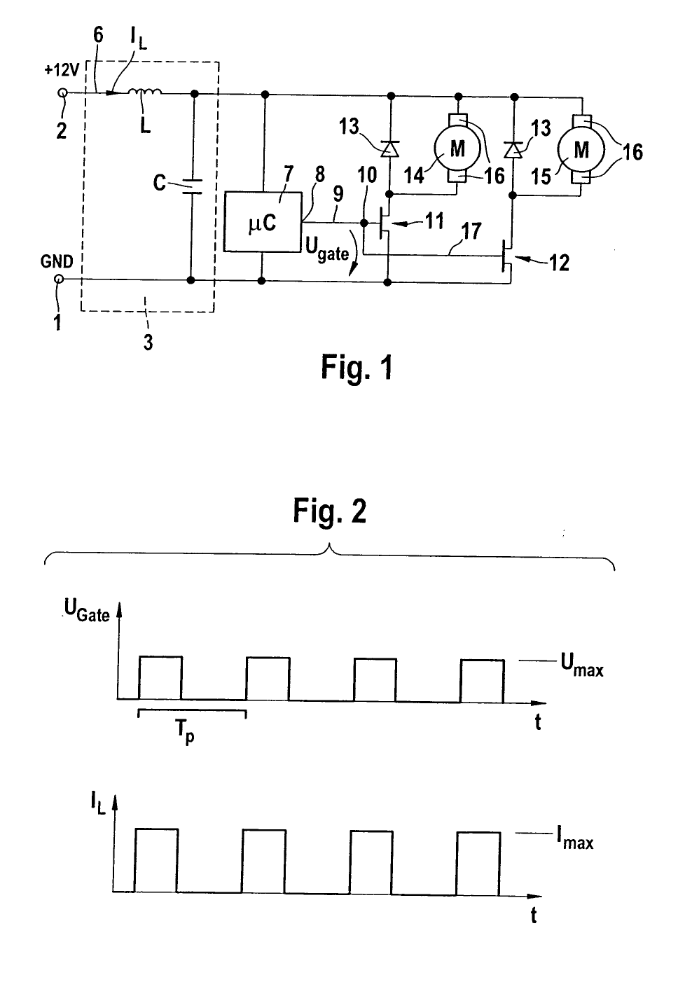

FIG. 1 shows an available circuit arrangement for controlling two electrical drives.

From the view according to FIG. 1, it is apparent that the circuit arrangement includes a grounded connection 1, as well as a supply voltage terminal 2, to which the vehicle battery may be connected at the circuit arrangement in a motor vehicle. The circuit arrangement according to the representation in FIG. 1 also includes an EMC measure, i.e. an inductor L and a capacitor C. To improve the electromagnetic compatibility of the circuit arrangement according to the representation in FIG. 1, inductor L and capacitor C are sized as a function of the magnitude of a current IL flowing in lead 6 of the circuit arrangement, and as a function of clock frequency f=1/Tₚ. For acoustical reasons, the clock frequency at which the circuit arrangement is driven is generally at frequencies above 20 kHz.

Furthermore, the circuit arrangement according to the representation in FIG. 1 includes a micro-controller 7 (μC) having an output 8, to which a first control line 9 is connected. A first power semiconductor component 11, e.g. a transistor, is controlled via first control line 9. First control line 9 contains a tapping point 10. Connected to tapping point 10 is a second control line 17, via which a second power semiconductor component 12, e.g. a transistor, is controlled. The two power semiconductor components 11 and 12 are activated by control voltage U_{Gate} applied to output 8 of micro-controller 7.

A first electrical drive 14 and a second electrical drive 15, which normally take the form of DC motors, are driven by the two power semiconductor components 11 and 12, respectively. A free-wheeling diode 13 is connected in parallel with both first electrical drive 14 and second electrical drive 15. Reference numeral 16 identifies pairs of brushes, which are assigned to both first electrical drive 14 and second electrical drive 15.

Inductor L accommodated in EMC measure 3, as well as capacitor C provided there, are normally sized as a function of the maximum current flowing in lead 6. The result of utilized inductors L and capacitors C is that a current flows, which is low-pass-filtered two times. EMC measure 3, which contains both inductor L and capacitor C, particularly improves the line-conducted radiation (emission) of the circuit arrangement according to the representation in FIG. 1. A disadvantage of the embodiment of the circuit arrangement represented in FIG. 1 is the sizes of inductor L and capacitor C, which are matched to maximum current Iₘₐₓ flowing in lead 6.

Control voltage (U_{Gate}) and lead current IL occurring in the lead at a first pulse duty factor may be taken from FIG. 2.

Control signal U_{Gate} applied to output 8 of micro-controller 7 (μC) controls the two power semiconductor components 11 and 12 in phase, via first control line 9 and second control line 17, respectively. In this manner, the curve of control signal U_{Gate} shown in FIG. 2 sets in during a time Tₚ, when the two power semiconductor components 11 and 12 are triggered. The signal is characterized by a pulse duration and a pulse pause following the pulse duration. In the case of a first pulse duty factor of, e.g. 40%, the duration of the pulse pause is designed to be longer than the pulse duration. A maximum voltage Uₘₐₓ sets in during the pulse duration.

During the pulse duration, lead current I_{L} resulting from control signal U_{Gate} according to FIG. 2 assumes its maximum current value Iₘₐₓ, which represents a design criterium for inductor L provided inside EMC measure 3, as well as for capacitor C situated there. During the pulse duration, maximum current values occur in lead 6 of the circuit arrangement according to the representation in FIG. 1, as a function of the voltage curve resulting from control signal U_{Gate}.

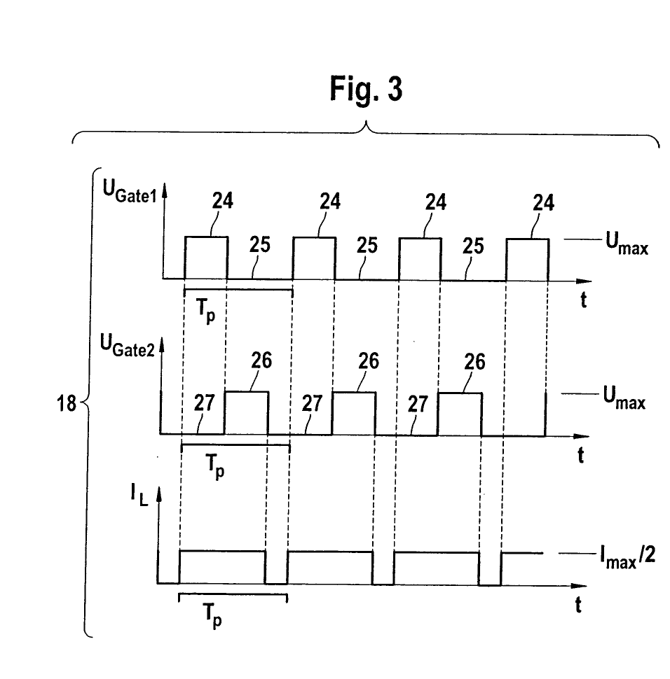

The control signal characteristic of two control signals U_{Gate1}, U_{Gate2} and the curve of the current in the lead at a first pulse duty factor may be taken from FIG. 3.

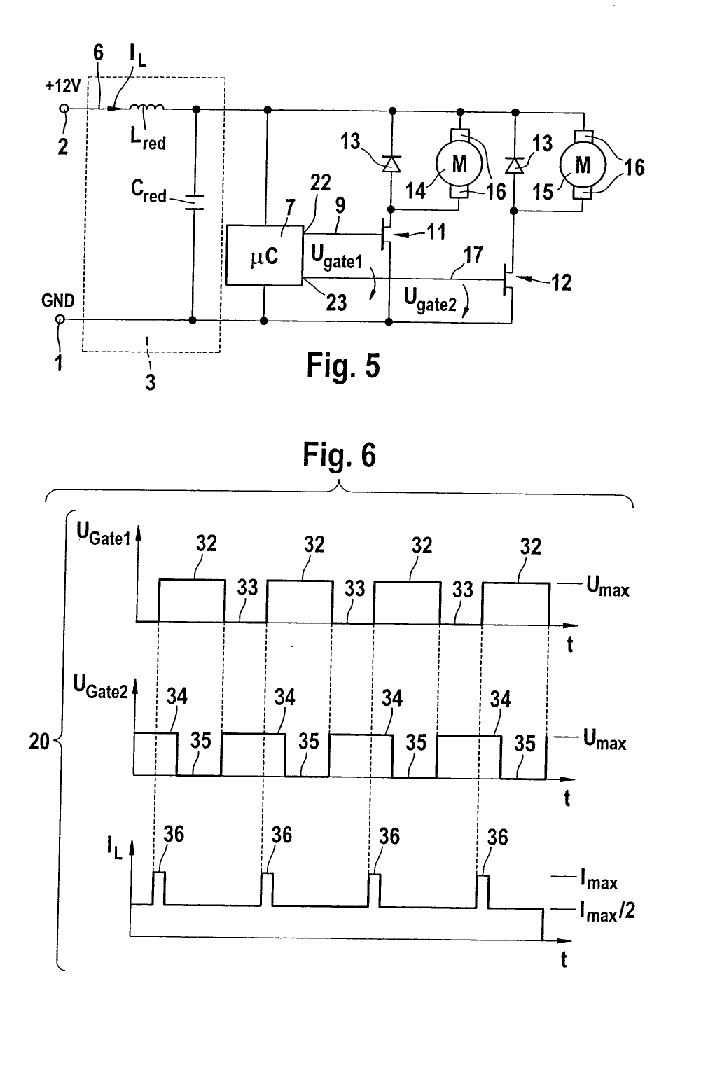

According to this control variant of the present invention for two power semiconductor components 11 and 12, control signal U_{Gate1} is applied to a first output of a micro-controller 7, while control signal U_{Gate2} is applied to an additional, second output provided at micro-controller 7 (μC). Both control signal U_{Gate1} and control signal U_{Gate2} are represented as pulse-width-modulated signals. In the case of a first pulse duty factor 18 set at micro-controller 7 (μC), control signal U_{Gate1} has a pulse duration 24, which is followed by a pulse pause 25. Pulse duration 24 and pulse pause 25 determine specific period Tₚ. During pulse duration 24, control signal U_{Gate1} is set to its maximum voltage Uₘₐₓ. Further control signal U_{Gate2} of micro-controller 7 (μC), which is applied to an additional output of micro-controller (μC), is clocked according to the set pulse duty factor, in this case pulse duty factor 18, so as to be staggered with respect to first control signal U_{Gate1}. Further control signal U_{Gate2} reaches its maximum voltage value Uₘₐₓ during its pulse duration 26. Pulse duration 26 of second control signal U_{Gate2} is followed by a pulse pause 27, which slightly exceeds pulse duration 26 at a first pulse duty factor 18 of, e.g. 40%, according to the representation in FIG. 3. The cut-off edge of first control signal U_{Gate1} coincides with the switching-on edge of second control signal U_{Gate2}, i.e. the second electrical drive (cf. FIG. 5, reference numeral 15) is switched on precisely when the first electrical drive (cf. FIG. 5, reference numeral 14) is switched off.

Using control signals U_{Gate1}, and U_{Gate2}, which are received by the two power semiconductor components 11 and 12, respectively, in order to control the electrical drives, a lead current I_{L}, which lies, in comparison with lead current I_{L} shown in FIG. 2, near an optimized electrical system current Iₘₐₓ/2, is generated in lead 6 in accordance with the representation in FIG. 5. Therefore, within one period Tₚ, a first approximation of a direct current is applied, which is, however, not yet completely uniform at first pulse duty factor 18 of approximately 40% shown in FIG. 3. The effective value of the lead current in lead 6, I_{L-eff}, is, however, markedly lower than the lead current in lead 6 according to the representation in FIG. 2. Effective lead current I_{L-eff} is yielded by the equation:

$${I}_{L - eff}^{2} = \frac{1}{T} {\int }_{0}^{T} {I}_{L}^{2} ( t ) ⅆ t$$

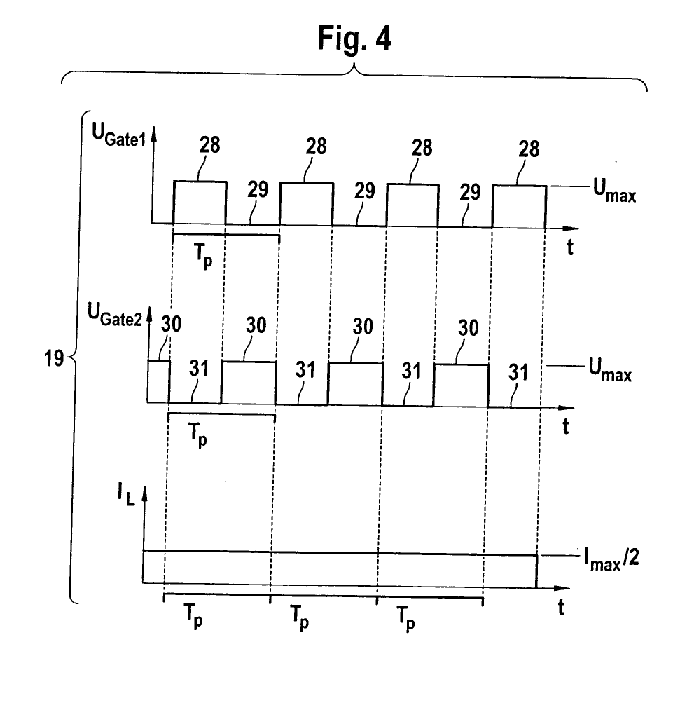

FIG. 4 shows the control-signal curves for two power semiconductor components and resulting lead current I_{L}, when the power semiconductor components are controlled, using an optimum pulse duty factor of 50%.

From the representation of FIG. 4, it is apparent that, during period Tₚ, control signal U_{Gate1} has a pulse duration 28, which is followed by a pulse pause 29 of equal duration. During pulse duration 28 of first control signal U_{Gate1}, this (the first control signal) assumes its maximum voltage value Uₘₐₓ. In contrast to control signal U_{Gate1}, further control signal U_{Gate2} applied to microcontroller 7 (μC) is time-staggered with respect to first control signal U_{Gate1}, pulse durations 30 of the second control signal being applied during pulse pauses 29 of first control signal U_{Gate1}. Conversely, pulse durations 28 of first control signal U_{Gate1} are applied during pulse pauses 31 of further, second control signal U_{Gate2}. Maximum voltage value Uₘₐₓ is also reached during pulse durations 30 of second, further control signal U_{Gate2}.

When the two power semiconductor components 11 and 12 are controlled according to the circuit arrangement in FIG. 5, a genuine direct current is generated in lead 6 of a motor vehicle electrical system. The current intensity of the current flowing in the electrical system of a motor vehicle, i.e. of lead current I_{L}, is half of maximum current Iₘₐₓ, compared to the lead current, which flows in an electrical system of a motor vehicle when electrical drives 14, 15 are controlled in an available manner according to FIG. 1 (cf. lead-current characteristic Iₘₐₓ according to FIG. 2). In the method provided by the present invention, the two power semiconductor components 11 and 12 are controlled, using a pulse duty factor of 50%, i.e. pulse durations 28 and 30 of control signals U_{Gate1}, U_{Gate2}, respectively correspond to the length of pulse pauses 29 and 31, respectively, of these signals.

As is apparent from FIG. 4, the cut-off edges of first control signal U_{Gate1} coincide, in each instance, with the switching-on edges of second control signal U_{Gate2}; i.e. second electrical drive 15, which is controlled by second control signal U_{Gate2}, is always switched on, when first drive 14 controlled by first control signal U_{Gate1} is switched off. In this manner, a genuine direct current sets in during period Tₚ.

Because the two power semiconductor components 11 and 12 (cf. representation according to FIG. 5) are controlled, using optimized pulse duty factor 19 of 50%, the inductors and capacitors situated inside an EMC measure 3 may be sized smaller, since, with regard to the design parameter of maximum tolerable current intensity, they must be designed for optimized electrical-system current Iₘₐₓ/2, and not for lead current Iₘₐₓ according to the representation in FIG. 2. This considerably lowers the unit volume of EMC measure 3.

FIG. 5 shows the circuit arrangement configured according to the exemplary embodiment of the present invention, having an EMC measure whose inductance and capacitance are reduced.

The circuit arrangement according to the representation in FIG. 5 also includes a grounded connection 1 and a supply-voltage terminal 2, to which, e.g. a vehicle battery may be connected. EMC measure 3 according to the representation in FIG. 5 has a reduced inductance L_{red}, as well as a reduced capacitance C_{red}. The circuit arrangement includes a lead 6, in which lead current I_{L} flows. In contrast to micro-controller 7 shown in FIG. 1, the circuit arrangement of the present invention according to FIG. 5 contains a micro-controller 7 (μC), which includes a first output 22 and a second output 23. First control line 9, via which first power semiconductor component 11 is controlled, is connected to first output 22 of micro-controller 7 (μC).

In contrast to the control line of first power semiconductor component 11 according to FIG. 1, the first control line does not include tapping point 10. Second power semiconductor component 12 is directly controlled by micro-controller 7 (μC), via second control line 17, which is connected to second output 23 of micro-controller 7 (μC). First control signal U_{Gate1} is transmitted via first control line 9; additional, second control signal U_{Gate2} is transmitted via second control line 17. In accordance with the pulse duty factor set at micro-controller 7, whether it is first pulse duty factor 18 (40%) represented in FIG. 3, optimized pulse duty factor 19 according to the representation in FIG. 4, or a third pulse duty factor 20 according to the representation in FIG. 6, the corresponding control-signal characteristics of control signals U_{Gate1} and U_{Gate2} are generated in control lines 9 and 17, respectively, which are connected to outputs 22, 23, respectively, of micro-controller 7.

If optimized pulse duty factor 19 (50%) is set at micro-controller 7 (μC), then control-signal characteristics U_{Gate1} and U_{Gate2} according to the representation in FIG. 4 are generated in control lines 9 and 17, respectively, so that optimized electrical-system current Iₘₐₓ/2 flows in lead 6 of the circuit arrangement according to FIG. 5. Therefore, the inductors and capacitors of EMC measure 3 may be sized smaller.

From the representation according to FIG. 6, it can be gathered that the two power semiconductor components of the circuit arrangement according to FIG. 5 are controlled, using an additional, third pulse duty factor.

When the two power semiconductor components 11 and 12 are controlled via control lines 9 and 17, respectively, of micro-controller 7 (μC), using a third pulse duty factor 20 (60%), the pulse duration of first control signal U_{Gate1} is indicated by reference numeral 32. Pulse duration 32 exceeds the duration of pulse pause 33 of first control signal U_{Gate1} during period Tₚ. Additional, second control signal U_{Gate2}, which is clocked by micro-controller 7 (μC) so as to be staggered with respect to first control signal U_{Gate1}, is made up of a pulse duration 34 and a pulse pause 35. At third pulse duty factor 20 of 60%, pulse duration 34 of second control signal U_{Gate2} exceeds the duration of pulse pause 35.

When the two power semiconductor components 11 and 12 for electrical drives 14, 15 are controlled, using third pulse duty factor 20 according to the representation in FIG. 6, lead current I_{L} is generated in lead 6 of the circuit arrangement, the lead current being made up of a direct-current portion of approximate magnitude Iₘₐₓ/2, as well as a pulsating current portion. Since the direct-current portion does not contribute to the effective capacitor current at this operating point, as well, the effective capacitor current is also considerably reduced in this case. At a pulse duty factor 20 of approximately 60%, the cut-off edge of first control signal U_{Gate1} controlling first electrical drive 14 also coincides with the switching-on edge of second control signal U_{Gate2} controlling second electrical drive 15. At third pulse duty factor 20 of 60% represented in FIG. 6, current peaks 36 of lead current I_{L} set in during period Tₚ.

The time-staggered control of the two electrical drives 14 and 15 provided by the present invention, i.e. the energizing of second electrical drive 15 by second control signal U_{Gate2} after the switching-off of first electrical drive 14 by first control signal U_{Gate1}, allows a double fan of a motor vehicle to be used for satisfying different functions, frequency f=1/Tₚ of lead current I_{L} always remaining unchanged. Thus, the coolant of the internal combustion engine may be cooled by electrical drive 14, and the heat exchanger of a motor-vehicle air conditioner or, alternatively, a power-steering system in a motor-vehicle, may be cooled by electrical drive 14 driving the second fan.

1. A method for controlling at least two electrical loads in a circuit arrangement, the method comprising:
controlling the at least two electrical loads with at least two pulse-width-modulated signals, wherein an inductor and a capacitor affect electromagnetic compatibility, and an inductor current flowing in a lead is buffered by the capacitor; and
generating the at least two pulse-width-modulated signals so as to be staggered in time;
wherein one of the electrical loads is switched on by one of the pulse-width-modulated signals, after the other one of the electrical loads is switched off by another one of the pulse-width-modulated signals.

2. The method of claim 1, wherein the another one of the pulse-width-modulated signals is a first control signal, the one of the pulse-width-modulated signals is a second control signal, and cut-off edges of the first control signal coincide with switching-on edges of the second control signal independently of a pulse duty factor.

3. The method of claim 1, wherein the electrical loads are controlled using a pulse duty factor of 50%.

4. The method of claim 3, wherein a direct current is generated in the lead to the electrical system of a motor vehicle at the pulse duty factor of 50%.

5. The method of claim 1, wherein the two electrical loads are controlled by respective, assigned power semiconductor components, which are assigned separate control lines, respectively, for transmitting the pulse-width-modulated signals.

6. The method of claim 3, wherein the pulse duty factor is set at a micro-controller.

7. The method of claim 2, wherein a frequency of the inductor current flowing in the line remains the same for different pulse duty factors of the pulse-width-modulated signals.

8. A device for controlling at least two electrical loads, comprising:
an inductor;
a capacitor; and
a micro-controller to control the electrical loads and to generate first and second control signals, wherein the micro-controller includes a first output and a second output, to which a first control line and a second control line are connected to provide synchronized control or clocked control of power semiconductor components;
wherein:
control signals that control the electrical loads include pulse-width-modulated signals,
the inductor and the capacitor affect electromagnetic compatibility, and an inductor current flowing in a lead is buffered by the capacitor,
the pulse-width-modulated signals are generated so as to be staggered in time, and
one of the electrical loads is switched on by one of the pulse-width-modulated signals, after the other one of the electrical loads is switched off by another one of the pulse-width-modulated signals.

9. The device of claim 8, wherein the power semiconductor components include at least one of a MOSFET transistor, a bipolar transistor, an IGBT transistor, and an IGCT transistor.

10. The device of claim 8, wherein the another one of the pulse-width-modulated signals is the first control signal, the one of the pulse-width-modulated signals is the second control signal, and cut-off edges of the first control signal coincide with switching-on edges of the second control signal independently of a pulse duty factor.

11. The device of claim 8, wherein the electrical loads are controlled using a pulse duty factor of 50%.

12. The device of claim 11, wherein a direct current is generated in the lead to the electrical system of a motor vehicle at the pulse duty factor of 50%.

13. The device of claim 8, wherein the electrical loads are controlled by respective, assigned ones of the power semiconductor components, which are assigned separate control lines, respectively, for transmitting the pulse-width-modulated signals.

14. The device of claim 11, wherein the pulse duty factor is set at the micro-controller.

15. The device of claim 10, wherein a frequency of the inductor current flowing in the line remains the same for different pulse duty factors of the pulse-width-modulated signals.
